(19) United States
(12) Patent Application Publication
(10) Pub. No.: US 2005/0223378 A1
(43) Pub. Date: Oct. 6, 2005

(54) Method and apparatus for enhancing computer application performance

(76) Inventor: Mehmet Musa, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/816,086

(22) Filed: Mar. 31, 2004

(51) Int. Cl. G06F 9/46

(52) U.S. Cl. 718/100

(57) ABSTRACT

Computer application performance is enhanced by parallelizing the processing of the received application launch argument list. One or more input argument files are identified in the argument list. Two or more parallel threads are created when there are two or more input argument files in the argument list. The input argument files are then processed using the parallel threads, and the results are synchronized if necessary.

### BACKGROUND

At one time, computer applications were executed on large main-frame systems and were loaded into memory from primitive medium such as punched-cards. In that early era, the computer was, for the most part, used in a sequential manner. In other words, one computer application would be loaded and then executed. Once that application was finished, a new application could then be loaded into the computer and subsequently executed. It may seem rather odd to bring up such ancient computer history, but it is worthy to note that many computer applications are still executed in a sequential manner. This archaic method of executing computer programs continues to this day; even in a time where computers can be found on just about every desktop in America.

What is even more difficult to understand is that the old paradigm of sequential execution of a computer application continues even on powerful servers where there a numerous processors working together in parallel. In these parallel-processor machines, execution of a computer application is still accomplished in a serial manner.

In a Unix based computer environment, a computer application is generally executed whenever a new command line is accepted from a user console. In this example, a user enters a command line. In response, a command executive included in the operating system (known as a shell in Unix jargon) parses the command line. When the command line is successfully parsed, a command executive included in the operating system will load an executable image of the computer application into working memory. Then, the command executive will cause a processor in the computing system to execute the computer application so loaded into the working memory. The executing application is often referred to as an instantiation (or instance) of the application.

There are examples where multiple instantiations of a computer application can be executed in parallel. For example, the Unix operating system provides a background execution mode. Using the background execution mode, a user can instantiate several instances of a computer application. These are then allowed to execute in parallel, usually by causing separate parallel processors included in the computing system to execute one or more executable images loaded in memory. From a very simplistic perspective, a separate parallel instance of a computer application can be launched using this type of background execution mode.

One problem with background execution is that execution of a computer application still requires entry by a user of a separate command line for each parallel instantiation launched in this manner. Another problem with this type of background execution is that the execution order of each instantiation can not be controlled. This is a real problem when a computer application operates on an input file and the output file it creates must be output in a user desired order. For example, a print command can be launched in the background mode so as to direct printed output to an output device. Imagine the resulting frustration when a computer user wants to arrange printer output in a desired sequence; but each instance of the print application executed in the background is allowed by the operating system to print output irrespective of the order of the individual background print commands entered by a user.

### SUMMARY

A method and apparatus for enhancing computer application performance comprises reception of an application launch argument list. One or more input argument files are identified in the argument list. Two or more parallel threads are created when there are two or more input argument files in the argument list. The input argument files are then processed using the parallel threads.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one representative embodiment of a method for enhancing computer application performance;

FIG. 2 is a flow diagram that depicts one example embodiment of a method for creating two or more parallel processing threads;

FIG. 3 is a flow diagram that depicts alternative embodiments of a method for determining a maximum quantity of parallel processing threads;

FIG. 4 is a flow diagram that depicts additional alternative embodiments of a method for determining a maximum quantity of parallel processing threads;

FIG. 5 is a flow diagram that depicts one illustrative alternative embodiment of a method for creating two or more parallel processing threads;

FIG. 6 is a flow diagram that depicts one example embodiment of a method for processing input files using parallel processing threads;

FIG. 7 is a flow diagram that depicts one alternative embodiment of a method for enhancing the performance of a computer application;

FIG. 8 is a flow diagram that depicts one example embodiment of a method for determining if an application is a candidate for enhancement;

FIG. 9 is a flow diagram that depicts one example method for launching parallel instantiations of a computer application;

FIG. 10 is a block diagram that depicts one example embodiment of a system for processing input argument files;

FIG. 11 is a data flow diagram that illustrates the operation of one exemplary embodiment of a system for processing files;

FIG. 12 is a data flow diagram that describes the operation of one embodiment of a maximum thread determination function FIG. 13 is a data flow diagram that illustrates an alternative illustrative embodiment of an application that includes an output organizer; and

FIG. 14 is a data flow diagram that illustrates the operation of an alternative embodiment of a file processing system.

### DETAILED DESCRIPTION

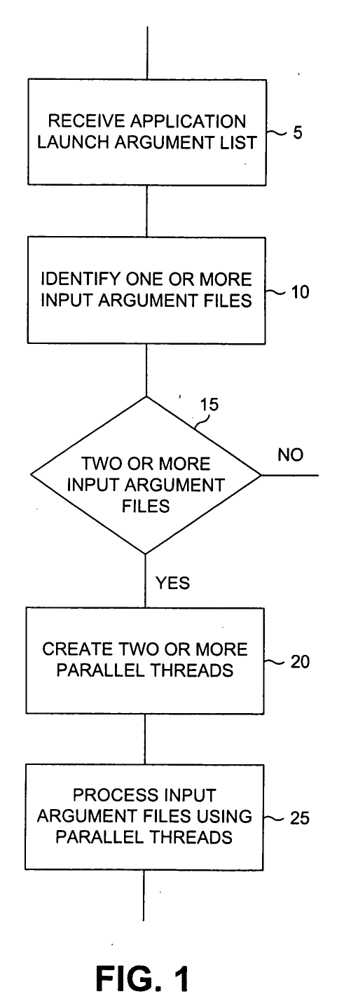

FIG. 1 is a flow diagram that depicts one representative embodiment of a method for enhancing computer application performance. According to this representative method, computer application performance is enhanced when an application first receives an application launch argument list (step 5). One or more input argument files are typically identified in the launch argument list (step 10). When two or more input argument file are identified in the launch argument list (step 15), two or more parallel threads are created (step 20). The input argument files are then processed by the parallel processing threads (step 25). For example, one separate thread is typically created for each input argument file. It should be noted that, according to one variation of the present method, an input file argument is allocated to one of the parallel threads in an arbitrary manner. For example, an input file argument can be assigned to a parallel thread on a random basis.

This representative method for enhancing computer application performance can be embodied in a computer program. In a practical sense, a computer application that embodies the present method typically includes some form of task manager that is capable of creating a processing thread for each input argument file identified in a launch argument list received by the application. One example of such computer program is a command line application. Yet another example of such a computer program is a generic application that supports a graphical user interface. Accordingly, the present method can be applied both to command line applications and graphical user interface (GUI) applications. It should be noted that the task manager may not necessarily be capable of creating a processing thread directly. Rather, the task manager may interact with processing thread management facilities provided by an operating system.

A command line application is typically stored as a file on computer readable medium. An operating system (e.g. UNIX) typically includes a command line parser. The command line parser interacts with a human user by receiving an alphanumeric string from a console. According to one example embodiment, a command line parser identifies the name of an executable file stored on a computer readable medium. This is accomplished by scanning the received alphanumeric string. Scanning of the received alphanumeric string is typically accomplished according to some pre-established lexical format. The command line parser then identifies additional arguments that may be included in the alphanumeric string received from the console. The command line parser passes the name of the executable file to a task executive.

According to one example embodiment, the task executive loads into memory an executable image of the identified file stored on a computer readable medium. Once the executable image is loaded in the memory, the task executive causes a processor in a computer system to execute instructions included in the executable image. The operating system also provides facilities that enable the processor, as it begins to execute the executable image loaded in memory, to access any additional arguments identified by the command line parser. While this description is representative of a UNIX-like operating system, the present method can be applied where other forms of command line program execution are utilized. Accordingly, even though much of the description provided herein is applicable to UNIX-like operating systems, the true scope and spirit of the claims appended hereto is intended to include various embodiments. Such various embodiments need not necessarily be UNIX compatible.

Many command line applications operate on input files specified by a human user as arguments in a command line. For example, “print” is a typical command line application that enables a user to direct the contents of a file to an output device (e.g. a printer). In the course of this description, the percent character (%) will be used to represent an operating system prompt. A user is expected to respond to the operating system prompt with a command. The command entered by a user is then scanned by a command line parser. With respect to the print command line application, a typical command line can be represented as follows:
(a) % print file1

Accordingly, example command (a) would be entered by a user desirous of printing the contents of a file named “file1”. Once this print command is executed, the user is then prompted to enter a new command. In the case were a user is desirous of printing the contents of several different files, the user is required to enter a corresponding number of print commands according to the command format introduced as command (a). Typically, user interaction dwells until a pending command is fully executed. As such, a user will need to enter these commands sequentially, waiting for a new command prompt once a previously entered command is fully executed.

According to the present method, a new command line format can be supported by an enhanced version of the print command. For example, a new command line format, as introduced in command (b) below, would include the name of the command (e.g. “print”) followed by a plurality of input file arguments. Accordingly, a typical command line commensurate with this new format can be represented as follows:
(b) % print file1 file2 file3

Interpreting the command provided in the new command line format results in execution of the print command according to the present method. The print command, which is embodied as one or more instruction sequences stored in a file on computer readable medium, is loaded into memory and a processor is caused to execute the computer program. Once a processor begins to execute the instruction sequences that embody the print command, it receives a plurality of input file arguments. According to the illustrative use case represented by command (b), the input file arguments would be “file 1”, “file2” and “file3”. According to the present method, the processor, as it continues to execute the instruction sequences that embody the print command, would create a plurality of parallel processing threads. Each input file argument would then be processed by a corresponding parallel processing thread. It should be noted that the “print” command is only one example of a command line application that embodies the present method. Other command line applications can include, but are not necessarily limited to asm (an assembler), cc (a “c” language compiler), pc (a Pascal language compiler), lp (a line printer utility) and zip (a file compression utility). It should be further noted that the present method can be widely applied, and any examples of command line applications are presented herein to illustrate and are not intended to limit the scope of the claims appended hereto. The scope of the claims appended hereto is also not intended to be limited by the structure or contents of any particular example of a command line (e.g. commands (a) and (b) above) presented here for illustrative purposes.

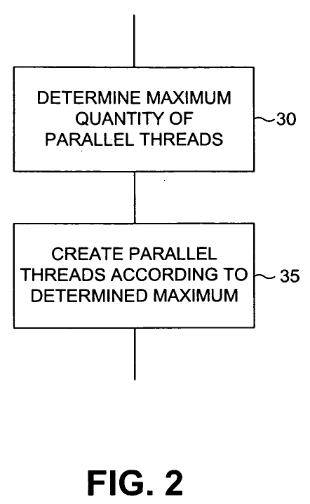

FIG. 2 is a flow diagram that depicts one example embodiment of a method for creating two or more parallel processing threads. As a processor executes one or more various instruction sequences that embody a computer application, the processor creates two or more parallel processing threads when there are two or more input file arguments identified in a launch argument list. According to one alternative example embodiment of the present method, creation of two or more parallel processing threads is accomplished by determining the maximum quantity of parallel processing threads that can be created (step 30). A quantity of parallel processing threads are then created according to the determined maximum quantity of parallel processing threads (step 35). Any particular computer application that embodies the present method will include a core function. This core function is seeded into each of the parallel processing threads enabling each of the processing threads to perform the core function of the application. It is important to note that a processing thread can be mistakenly considered to be an independent instantiation of a computer application that embodies the present method. A more proper perspective is to view each processing thread as an instantiation of the core function that would be included in an application that would not otherwise be capable of accepting a plurality of input argument files.

Each processing thread is established, according to one example embodiment, by requesting a thread allocation from an operating system. Such a thread allocation, according to this example, includes an allocation of memory that can be used to store one or more instruction sequences. As such, the creation of an instantiation of the core function is accomplished by loading into an allocated memory one or more instruction sequences that embody the core function and then requesting the operating system to schedule processing resources for the core function. As such, when a processor begins to execute the core function instruction sequences, the core function of the computer application is realized.

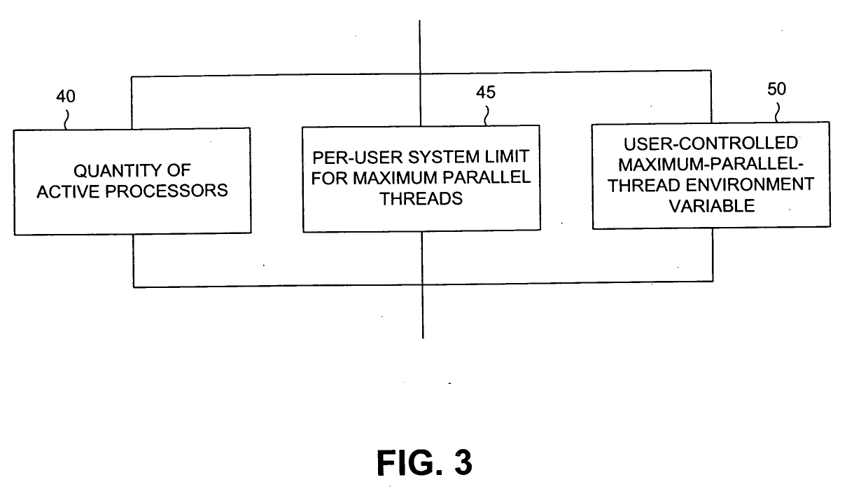

FIG. 3 is a flow diagram that depicts alternative embodiments of a method for determining a maximum quantity of parallel processing threads. According to one alternative embodiment of the present method, the maximum number of parallel processing threads that can be created is determined according to the quantity of active processors available in a computing system (step 40). Modernly, even low-end workstations and servers can include multiple parallel processors. In a multi-processor computing system, processing resources are typically managed by an operating system. Accordingly, a task manager included in the operating system remains cognizant of processor activity within the computing system. According to one illustrative example embodiment, the quantity of active processors available in a computing system is determined by consulting environment variables managed by the operating system. According to yet another alternative example embodiment, the maximum quantity of parallel processing threads that can be created is set according to a per-user system limit for the maximum quantity of parallel threads that can be created within a particular environment (step 45). One example of an operating system provides separate partitions for each user that can use a computing system. Each of these separate partitions is managed by various environment variables maintained by the operating system. One such environment variable can include a per-user system limit that is set by a privileged user (in a UNIX-like system, this is commonly known as a root). As such, the privileged user can specify the maximum quantity of parallel processing threads that can be created within a particular partition. The per-user system limit is generally only altered on an occasional basis. Typically, an application cannot alter such a per-user system limit. According to yet another illustrative alternative embodiment, a user-controlled maximum-parallel-thread environment variable is used to establish the quantity of parallel threads that can be created (step 50). One example embodiment of an operating system maintains an environment variable known as a maximum-parallel-thread (MPT) environment variable. The actual name of the MPT variable can vary according to what type of operating system is used to control a computing system. For example, in a UNIX-like operating system, the MPT variable is called a maximum number of threads (MAX_NUMBER_OF_THREADS) variable. This example embodiment of an operating system allows a user (i.e. an application executing within a particular user partition) to modify the value stored in the MPT environment variable. Accordingly, this illustrative alternative embodiment of the present method sets the maximum quantity of parallel processing threads that can be created according such an MPT environment variable. These various alternative embodiments of the present method are presented here to illustrate and are not intended to limit the scope of the claims appended hereto.

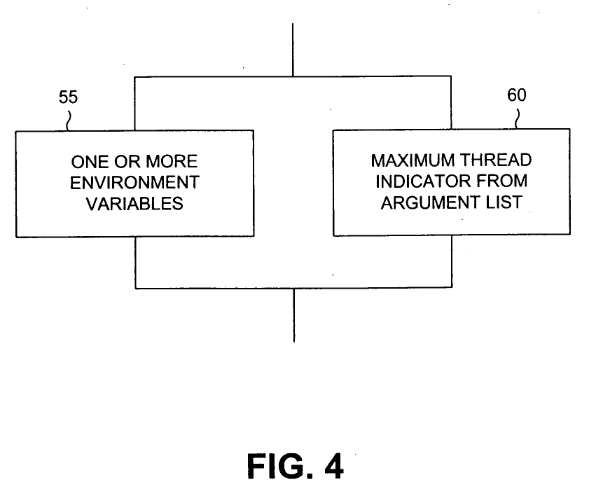

FIG. 4 is a flow diagram that depicts additional alternative embodiments of a method for determining a maximum quantity of parallel processing threads. According to one such additional alternative embodiment, one or more environment variables (step 55) maintained by the operating system are utilized to establish a maximum quantity of parallel processing threads that an application embodying the present method is allowed to create. It is difficult to enumerateall of the various types of environment variables that can be maintained by any particular embodiment of an operating system. However, the scope of the claims appended hereto is intended to encompass derivative methods wherein the maximum quantity of parallel processing threads that can be created by an application is established according to one or more of the various types of environment variables maintained by a particular operating system. According to another alternative embodiment, an application embodying the present method receives a maximum thread indicator as an argument (step 60) included in the application launch argument list received by the application when it is launched.

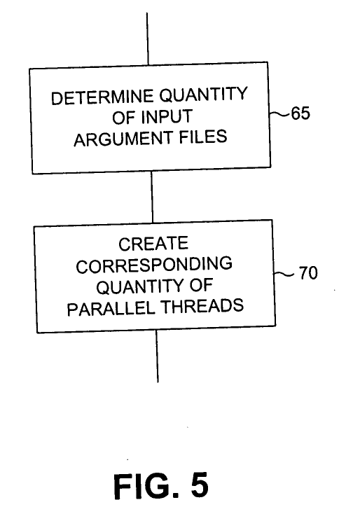

FIG. 5 is a flow diagram that depicts one illustrative alternative embodiment of a method for creating two or more parallel processing threads. According to this alternative embodiment of the present method, the quantity of input argument files is determined (step 65). An application embodying the present method, according to one alternative embodiment, simply counts the number of input argument files that are included in an application launch argument list. According to one alternative embodiment, an application can rely on an operating system to provide a count of a quantity of input argument files (e.g. UNIX provides an argument count variable “argc”). Once the number of input argument files is determined, this alternative method provides for creating a corresponding quantity of parallel processing threads (step 70). Parallel processing threads, according to this illustrative alternative embodiment, are created in accordance with the descriptions proffered supra with respect to FIG. 2.

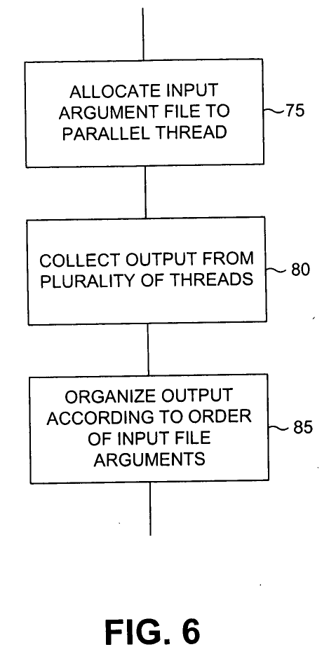

FIG. 6 is a flow diagram that depicts one example embodiment of a method for processing input files using parallel processing threads. Once an instantiation (i.e. one of a plurality of parallel processing threads) of a core function of a computer application is executed by a processing resource in a computing system, it typically causes a processor to fetch information from an input file.

Accordingly, this example method for processing input files using parallel processing threads provides for allocating the input argument files to the various parallel processing threads (step 75) created by the computer application. Each file argument included in a list of arguments received by an application is dispatched to one of the parallel processing threads. A parallel processing thread uses the file argument it receives as a means of determining which file it is to use as input. Allocating an input argument file to a processing thread, according to one variation of the present method, is accomplished by a centralized process. For example, a computer application that embodies the present method can include a task manager process. Such a task manager process, according to one alternative embodiment, directs a particular parallel processing thread to operate on a particular input argument file. According to yet another alternative variation of the present method, allocation of an input argument file is accomplished in a distributed manner. For example, a computer application that embodies the present method can place unprocessed input file arguments in a processing queue. Accordingly, a particular parallel processing thread can operate on a file argument that the parallel processing thread retrieves from the processing queue.

According to yet another example alternative method, the output generated by a particular parallel processing thread may not be generated in a sequence consistent with the sequence of the arguments included in the application launch argument list received by the application upon startup. In order to alleviate this problem, this alternative method provides for collecting the output generated by a plurality of parallel processing threads (step 80) and organizing the output according to the order of the input file arguments included in the application launch argument list (step 85).

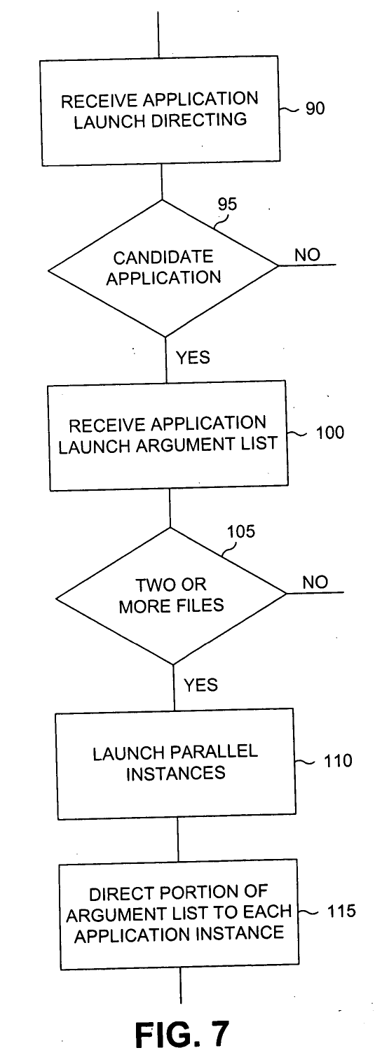

FIG. 7 is a flow diagram that depicts one alternative embodiment of a method for enhancing the performance of a computer application. Thus far described has been an embodiment of the present method that can be incorporated into the design of a computer application. This alternative method is more suitably incorporated into an operating system. For example, a command line parser can embody this alternative method for enhancing computer application performance. According to one example method, the performance of a computer application is enhanced by receiving an application launch directive (step 90). According to one example method, the launch directive is received as an alphanumeric string from a console. The application launch directive will include, according to one variation of the present method, the name of a computer application (e.g. “print”) and a launch argument list. According to this alternative method, certain computer applications are considered “candidate applications”. A candidate application includes an application that can be executed in a plurality of parallel instantiations and wherein each parallel instantiation of the application can operate on a particular input argument file. Accordingly, the present method provides for determining if the application specified in the application launch directive is such a candidate application (step 95).

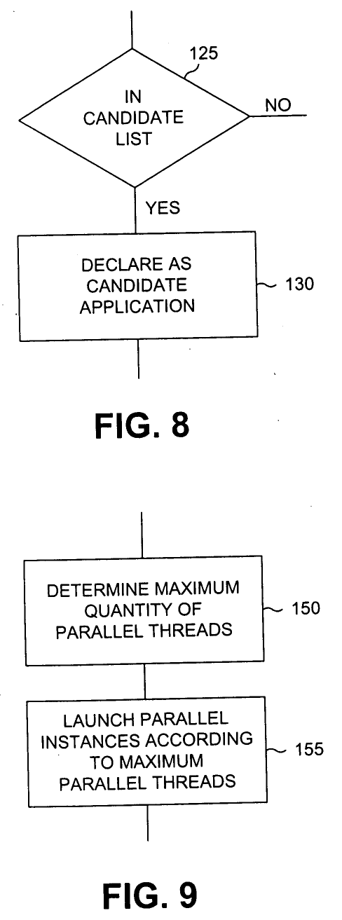

FIG. 8 is a flow diagram that depicts one example embodiment of a method for determining if an application is a candidate for enhancement. According to this example method, an application specified in an application launch directive is compared against an enumeration of candidate applications. When the specified application is found in the enumeration of candidate applications (step 125), the specified application is declared to be a candidate application (step 130). As already discussed, a candidate application includes an application that can be executed in a plurality of parallel instantiations. According to one example embodiment, a command line parser provides facilities for comparing a specified application against an enumeration of candidate applications.

FIG. 7 further illustrates that, according to this example method for enhancing computer application performance, an application launch argument list is received (step 100). According to one example embodiment, a command line parser can scan an application launch directive in order to identify input file arguments included therein. When there are two or more input file arguments (step 105) included in the application launch directive, the present example method provides for launching parallel instantiations of the application (step 110). A portion of the argument list is directed to each instantiation of the application (step 115). Each instantiation of the application is allowed to operate on a particular input file argument. As can be appreciated from this description, a wide variety of computer applications can be initiated in this manner. The computer applications themselves need not be modified in order to incorporate the present method. An operating system (e.g. a command line parser included therein) can embody this alternative method for enhancing computer application performance.

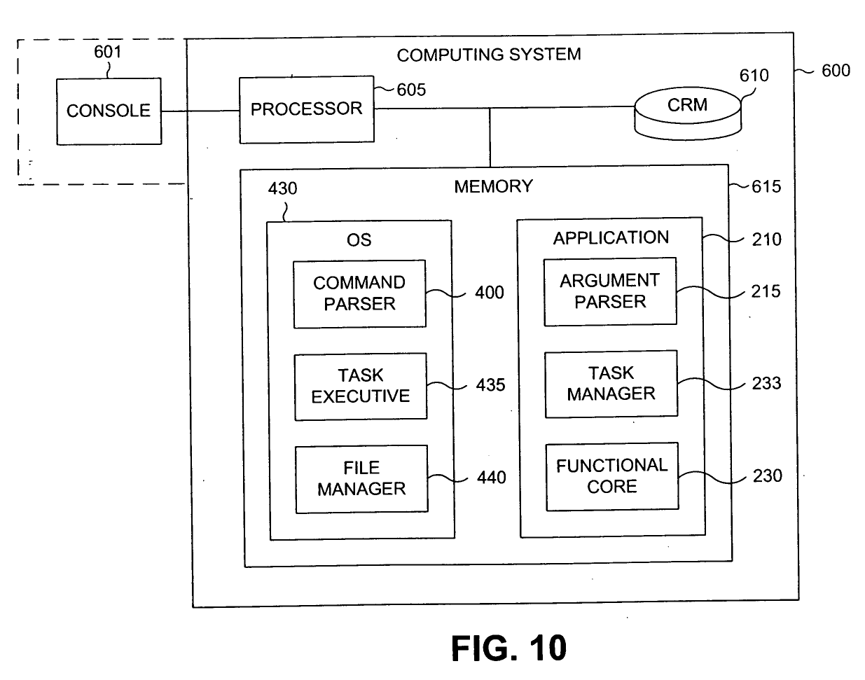

FIG. 9 is a flow diagram that depicts one example method for launching parallel instantiations of a computer application. According to this alternative example method for launching parallel instantiations of a computer application, a maximum quantity of parallel processing threads is determined (step 150). The maximum quantity of parallel processing threads is used to limit the number of parallel instantiations of the computer application that are instantiated (step 155). Determination of the maximum quantity of parallel processing threads can be accomplished using various methods and techniques herein fore described.

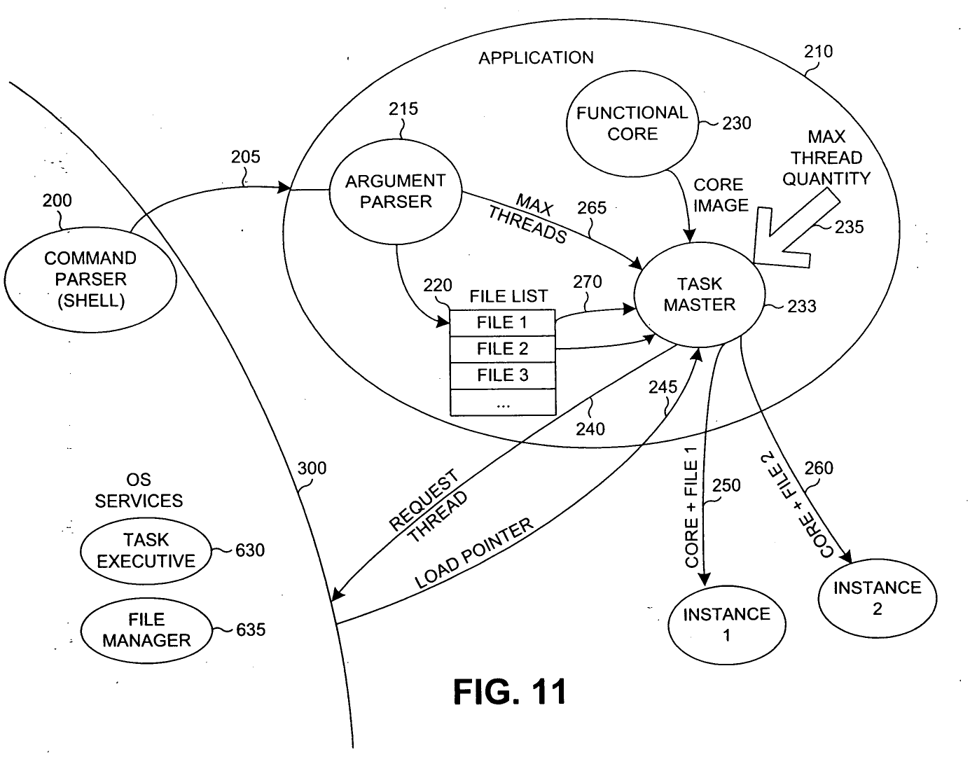

FIG. 10 is a block diagram that depicts one example embodiment of a system for processing input argument files. According to this example embodiment, a system (e.g. a computing system) 600 comprises one or more processors 605, a computer readable medium 610 and a memory 615. According to one alternative embodiment, a system 600 further includes a console 601 for receiving an argument list. Also included in this example embodiment of the system 600 are one or more functional modules. A functional module is typically embodied as an instruction sequence. An instruction sequence that implements a functional module, according to one alternative embodiment, is stored in the memory 615. The reader is advised that the term “minimally causes the processor” and variants thereof is intended to serve as an open-ended enumeration of functions performed by the processor 605 as it executes a particular functional module (i.e. instruction sequence). As such, an embodiment where a particular functional module causes the processor 605 to perform functions in addition to those defined in the appended claims is to be included in the scope of the claims appended hereto.

The functional modules (i.e. their corresponding instruction sequences) described thus far that enable processing of input argument files according to the present method are, according to one alternative embodiment, imparted onto computer readable medium. Examples of such medium include, but are not limited to, random access memory, read-only memory (ROM), compact disk ROM (CD ROM), floppy disks, hard disk drives, magnetic tape and digital versatile disks (DVD). Such computer readable medium, which alone or in combination can constitute a stand-alone product, can be used to convert a general-purpose computing platform into a device capable of processing input argument files according to the techniques and teachings presented herein. Accordingly, the claims appended hereto are to include such computer readable medium imparted with such instruction sequences that enable execution of the present method and all of the teachings herein described.

FIG. 10 further illustrates that, according to one alternative embodiment of the system 600, there is included in the memory 615 a functional module called an application 210. According to one alternative embodiment, the application 210 has included therein additional functional modules called an argument parser 215, a taskmaster 233 and a functional core 230.

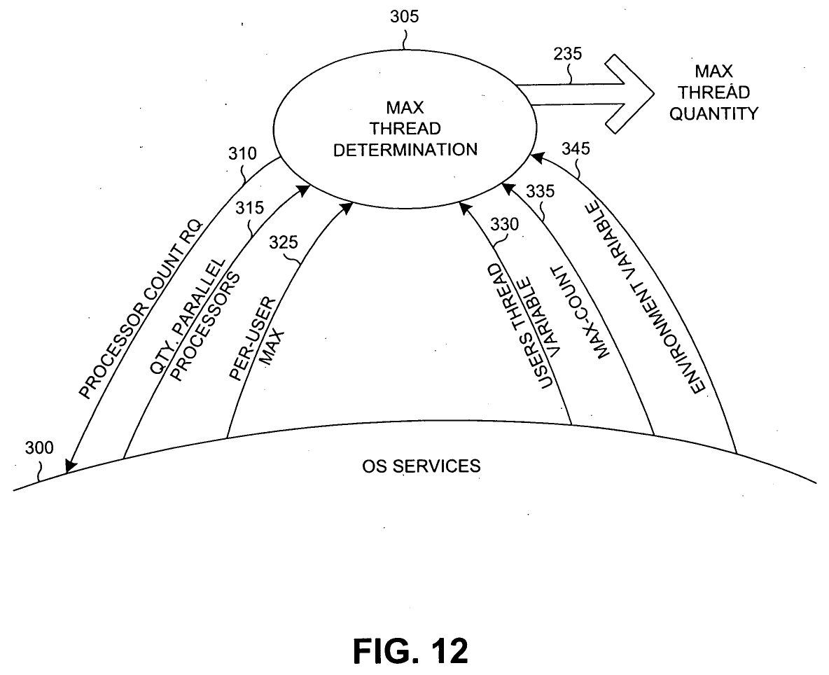

FIG. 11 is a data flow diagram that illustrates the operation of one exemplary embodiment of a system for processing input argument files. According to this exemplary embodiment, the processor 605 executes an operating system 300 that includes therein a command parser 200. The command parser is sometimes known as a shell. The shell 200, when executed by the processor 605, minimally causes the processor 605 to receive an argument list. Typically, the processor 605 is also minimally caused by the shell 200 to receive a command from a user. Such a command typically includes the name of an application that the user is desirous of executing. Accordingly, once the shell 200 identifies a particular application, for example the application 210 of this exemplary embodiment, the shell 200 further causes the processor 605 to execute a task executive 630 included in the operating system 300. It should be noted that this interaction between the shell 200 and a task executive 630 is presented herein for illustration purposes only is not intended to limit the scope of the claims appended hereto. In fact, the present system 600 can include various mechanisms enabling a user to enter a command and subsequently execute a particular application according to command. What is important to note throughout this description is the fact that, according to this exemplary embodiment, the processor 605 executes the application 210 stored in the memory 615. The processor 605, as it begins to execute the application 210, is minimally caused by said application 210 to receive 205 an argument list. The processor 605 receives the argument list either directly or by means of a reference (e.g. a pointer).

Included in this exemplary embodiment of an application 210 is an argument parser 215 that, when executed by the processor 605, minimally causes the processor to identify one or more input argument files in the argument list received 205 from the shell 200. The argument parser 215, according to one alternative embodiment of an application 210, minimally causes the processor 605 to extract individual input file arguments from the argument list received 205 from the shell 200. These can be stored in a file list buffer 220. According to yet another alternative embodiment of an argument parser, the argument parser 215 further minimally causes the processor 605 to extract a maximum thread indicator from the argument list. The maximum thread indicator is then provided 265 to a task manager 233 included in this exemplary embodiment of an application 210.

A functional core module 230 included in this exemplary embodiment of an application 210, when executed by the processor 605, minimally causes the processor to direct an output stream to computer readable medium (CRM) according to an input file stored on the computer readable medium. Generally, the functional core module 230 will vary according to various embodiment of the application 210. Such variation in the functional core module 230 is typically commensurate with the type of application 210 represented by the exemplary embodiment described herein. For example, where the application 210 is a printing application, the functional core module 230 will contain instructions that, when executed by the processor 605, minimally causes the processor 605 to direct a representation of an input file to an output device (e.g. a printer). According to yet another example, where the application 210 is an assembler for translating assembly language statements into a binary file, the functional core module 230 will contain instructions that, when executed by the processor 605, minimally cause the processor 605 to convert assembly language statements contained in an input file into a binary instruction sequence file. These are but two examples of variations that may become manifest in various embodiments in a functional core module 230. It is important to emphasize that introduction of these examples into this description is for the purpose of illustrating the methods and apparatus as applicable to the claims appended hereto. These and other such examples of a functional core module 230 are not intended to limit the scope of the appended claims.

The taskmaster module 233 of this exemplary embodiment, when executed by the processor 605, minimally causes the processor 605 to create one or more instantiations of the functional core module 230 and to direct (250, 260) to the corresponding instantiations of the functional core module 230 an input argument file identified by the processor 605 when it executes the argument parser 215. The taskmaster module 233 further minimally causes the processor 605 (or another assignee processor) to execute each instantiation of the functional core module. According to one alternative embodiment, the taskmaster module 233 causes the processor 605 to create an instantiation by dispatching a thread request 240 to a task executive 630 included in an operating system 300. In response, the taskmaster 233 typically receives a load pointer 245. The taskmaster 233 then retrieves the functional core module 230 as a core image and loads this core image into memory according to the load pointer 245. Other communications between the taskmaster 233 and a task executive 630 enable execution of a particular instantiation using one of several parallel processors that may be included in a system.

FIG. 11 also illustrates that the taskmaster 233, according to one alternative embodiment, further minimally causes the processor 605 to receive a maximum thread quantity value 235. According to this alternative embodiment, the taskmaster module 233 causes the processor 605 to create one or more instantiations of the functional core module 230 by first minimally causing the processor 605 to determine the maximum quantity of parallel threads that can be created in a system and then minimally causing the processor 605 to create a quantity of instantiations of the functional core module 230 according to the determined maximum quantity of parallel threads. According to yet another alternative embodiment, the taskmaster module 233 minimally causes the processor 605 to create a quantity of instantiations of the functional core module 230 according to a maximum thread indicator 265 received from the argument parser 215.

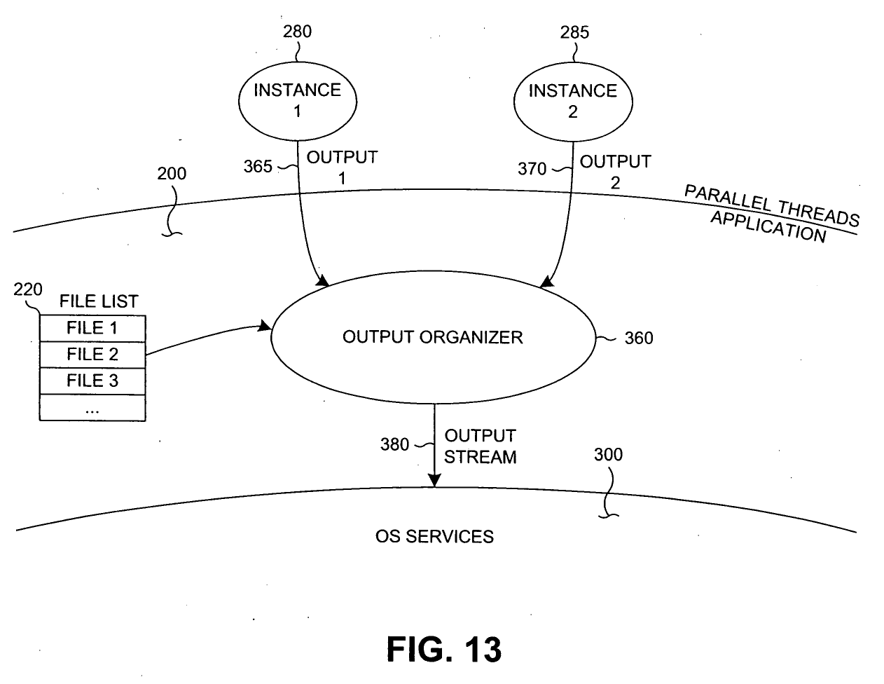

FIG. 12 is a data flow diagram that describes the operation of one embodiment of a maximum thread determination function. According to yet another alternative embodiment, the taskmaster module 233 includes a maximum thread determination function 305. When executed by a processor 605, the maximum thread determination function 305 minimally causes the processor 605 to determine the quantity of parallel threads that can be created by consulting various system and/or environment variables. For example, one alternative embodiment of a maximum thread determination function 305 minimally causes the processor 605 to request a processor count 310 from the operating system 300. In response, the operating system 300 provides an indication, of the number of active processors available 315 in a computing system. The maximum thread determination function 305 then minimally causes the processor 605 to establish as a maximum thread quantity 235 the indication of the number of active processors 315 provided by the operating system 300. According to yet another alternative embodiment, the maximum thread determination function 305, when executed by the processors 605, minimally causes the processor 605 to establish as a maximum thread quantity 235 a value maintained in a per-user maximum parallel thread limitation 325 provided by the operating system 300. According to yet another alternative embodiment, the maximum thread determination function 305 minimally causes the processor 605 to use a user-controlled maximum-thread 330 state-variable as the basis for the maximum quantity of threads 235 that can be created. And, according to yet another alternative example embodiment, the processor 605, as it executes the maximum thread determination function 305, is minimally caused to use one or more other environment variables 345 that can be provided by the operating system 300.

FIG. 13 is a data flow diagram that illustrates an alternative illustrative embodiment of an application that includes an output organizer. As previously discussed, output from various parallel instantiations of a functional core may not necessarily be generated in a desired sequence. Accordingly, this alternative illustrative embodiment of an application 210 further comprises an output organizer module 360. The output organizer module 360, when executed by the processor 605, minimally causes the processor 605 to collect output files (365, 370) from the one or more instantiations (280, 285) of the functional core 230 instantiated by the taskmaster 233. The output from each instantiation is organized according to the order of input file arguments included in an argument list received by the application 210 when the application 210 is first launched. According to one alternative example embodiment, the output organizer 360 orders output according to a sequence of file arguments found in the file list buffer 220 created by the processor 605 when it executes the argument parser 215.

FIG. 10 also illustrates that, according to yet another alternative embodiment, a system for processing input argument files 600 comprises one or more processors 605, a computer readable medium 610 and a memory 615. According to this alternative embodiment, included in the memory are functional modules embodied as instruction sequences including an operating system 430. According to this alternative embodiment, the operating system includes a command parser 400 and a task executive 435. According to yet another alternative embodiment, the operating system further includes a file manager 440. According to yet another alternative embodiment, a system for processing files 600 further includes a console 601 which can be used to receive an application launch directive from a user.

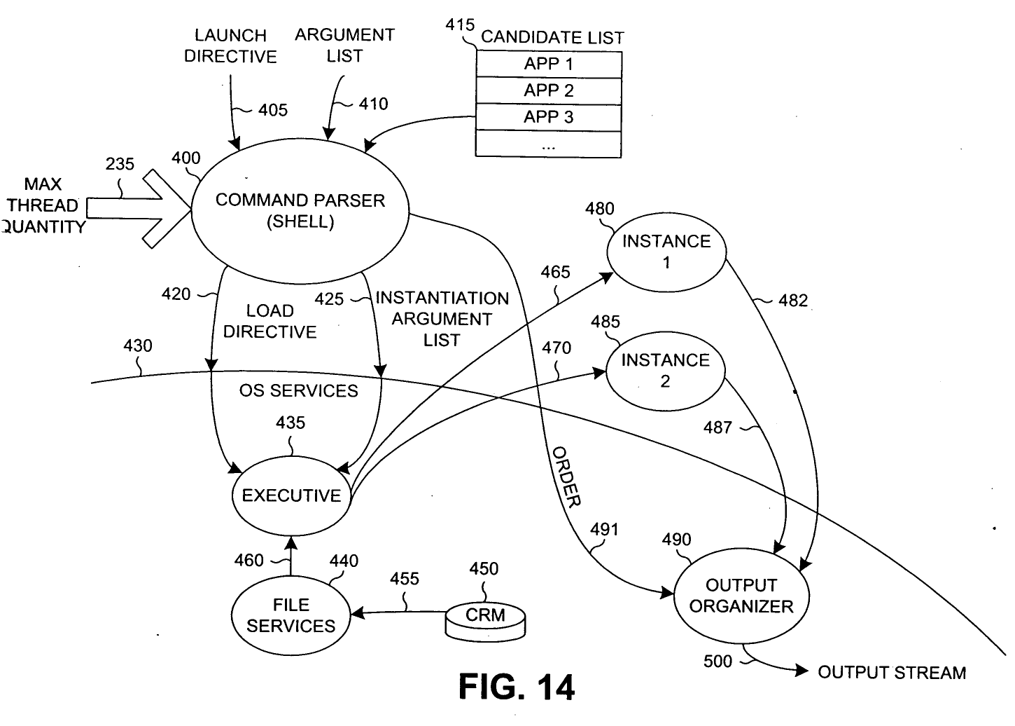

FIG. 14 is a data flow diagram that illustrates the operation of an alternative embodiment of an input argument file processing system. The command parser 400 of this alternative embodiment, which is sometimes referred to as a shell, is capable of interacting with a user. Accordingly, the command parser 400, when executed by the processor 605, minimally causes the processor 605 to receive a launch directive 405. The launch directive 405 typically includes the name of an application stored on the computer readable medium (CRM) 450. The command parser 400, when executed by the processor 605, further minimally causes the processor 605 to receive an argument list 410. It should be noted that according to one alternative embodiment of a command parser 400, the argument list 410 is included in the launch directive 405. These are merely examples of various embodiments of a command parser 400. These example embodiments are not intended to limit the scope of the claims appended hereto.

The command parser 400 of this example embodiment, when executed by the processor 605, minimally causes the processor to identify an application included in the launch directive 405. The command parser 400 further minimally causes the processor 605 to identify one or more input argument files in the argument list 410. The command parser 400 further minimally causes the processor 605 to generate a plurality of load directives 420 and corresponding instantiation argument lists 425. These are then made available to the task executive 435 included in the operating system 430. It should be noted that the command parser 400 generates a plurality of load directives 420 and corresponding instantiation argument lists 425 when an application specified in a launch directive 405 is a candidate for enhancement and when there are two or more input argument files in the argument list 410. According to one alternative embodiment of a command parser 400, the command parser 400 minimally causes a processor 605 to determine if an application is a candidate for enhancement by minimally causing the processor 605 to determine if the application specified in the launch directive 405 is included in a candidate application list 415. It should be noted that any particular examples of candidate applications presented in the figure are not intended to limit the scope of the appended claims.

According to yet another example alternative embodiment, a command parser 400, when executed by the processor 605, minimally causes the processor 605 to generate a plurality of load directives 420 and corresponding instantiation argument lists 425 by first determining the maximum quantity of parallel processing threads that can be created. A quantity of load directives 420 and corresponding instantiation argument lists 425 are then generated according to the determined maximum quantity of parallel processing threads. Various alternative embodiments of a command parser 400 provided for determination of the maximum quantity of parallel processing threads in accordance with other teachings provided herein. For example, there are embodiments of this command parser 400 that provide for determination of a maximum quantity of parallel processing threads as discussed with respect to FIG. 12. Accordingly, the command parser 400 of this alternative embodiment receive a maximum thread quantity 235 from a maximum thread determination function 305 included therein. Yet another example embodiment of a command parser 400 establishes a maximum quantity of parallel processing threads according to a maximum thread indicator included in the argument list 410. This alternative example embodiment provides for allowing a user to specify the maximum thread indicator when conveying a launch directive 405 and an argument list 410 to the command parser 400.

According to yet another alternative example embodiment, the command parser 400, when executed by the processor 605, minimally causes the processor 605 to generate a plurality of load directives 420 and corresponding instantiation argument lists 425 by minimally causing the processor 605 to determine the quantity of input file arguments included in the argument list 410. A quantity of load directives 420 and corresponding instantiation argument lists 425 are then generated according to the determined quantity of input file arguments.

The task executive 435 of this example embodiment, when executed by the processor 605, minimally causes the processor 605 to create a separate instantiation of an application specified in a load directive 420. This, according to one alternative embodiment, is accomplished by minimally causing the processor 605 to retrieve 455 an executable image of an application from the computer readable medium 450. Typically, the processor 605 executes a file manager 440 included in one alternative embodiment of an operating system 430. Accordingly, the task executive 435 minimally causes the processor to receive 460 an executable image of an application from the file manager 440 and subsequently load (465, 470) the application into memory. The task executive 435 further minimally causes the processor 605 to schedule execution of each application instance (480, 485). Such execution, according to one alternative example embodiment, is performed by an assignee processor. According to one alternative embodiment, a system for processing files 600 includes a plurality of processors 605. Hence, one of the processors 605 included in the system 600 of this alternative embodiment is assigned to execute and instance of the application (480, 485). According to one illustrated embodiment such an application, when executed by the assignee processor, minimally causes the assignee processor to direct an output stream to the computer readable medium 450. The assignee processor is minimally caused to generate the output stream according to an input file stored on the computer readable medium 450.

Yet another alternative example embodiment of a file processing system 600 includes an output organizer 490 in the operating system 430. According to this alternative example embodiment, the command parser 400, when executed by the processor 605, further minimally causes the processor 605 to provide an order list 491 to the output organizer 490. An application instance (480, 485) executing in a file processing system 600 of this alternative embodiment is directed to provide output (482, 485) to the output organizer 490. When executed by a processor 605, the output organizer 490 minimally causes the processor 605 to organize the output (482,487) received from a plurality of instantiations of an application according to the order list 491 received from the command parser 400. The output organizer 490 further minimally causes the processor 605 to generate an ordered output stream 500.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

1. A method for enhancing computer application performance comprising:
receiving an application launch argument list;
identifying one or more input argument files in the application launch argument list;
creating two or more parallel threads when there are two or more input argument files; and
processing the input argument files using the parallel threads.

2. The method of claim 1 wherein creating two or more parallel threads comprises:
determining the maximum quantity of parallel threads that can be created; and
creating a quantity of parallel threads according to the quantity of parallel threads that can be created.

3. The method of claim 2 wherein determining the quantity of parallel threads that can be created comprises determining the quantity of parallel threads that can be created according to at least one of a number of active processors, a per-user maximum parallel thread system limitation and a user-controlled maximum-parallel thread environment variable.

4. The method of claim 2 wherein determining the quantity of parallel threads that can be created comprises determining the quantity of parallel threads that can be created according to one or more environment variables.

5. The method of claim 2 wherein determining the quantity of parallel threads that can be created comprises:
receiving a maximum thread indicator from the application launch argument list; and
setting the quantity of maximum parallel threads according to the maximum thread indicator.

6. The method of claim 1 wherein creating two or more parallel threads comprises:
determining the quantity of input argument files; and
creating a quantity of parallel threads according to the quantity of input argument files.

7. The method of claim 1 wherein processing the input argument files comprises:
allocating an input file to a parallel thread;
collecting output from the parallel thread; and
organizing the output from the parallel thread according to the order of input file arguments included in the application launch argument list.

8. A method for enhancing computer application performance comprising:
receiving an application launch directive;
determining if the application launch directive specifies an application that is a candidate for enhancement;
receiving an application launch argument list;
launching two or more parallel instances of the application when the application is a candidate for enhancement and when there are a plurality of input argument files included in the application launch argument list; and
directing to each application instance an instantiation application launch argument list that includes a corresponding one of the input argument files included in the application launch argument list.

9. The method of claim 8 wherein determining if the application is a candidate for enhancement comprises determining if the application is included in an enumeration of one or more candidate applications.

10. The method of claim 8 wherein launching two or more parallel instances of the application comprises:
determining the maximum quantity of parallel threads that can be created; and
launching a quantity of parallel instances of the application according to the maximum quantity of parallel threads.

11. The method of claim 10 wherein determining the maximum quantity of parallel threads that can be created comprises determining the quantity of parallel threads that can be created according to at least one of a number of active processors, a per-user maximum parallel thread system limitation and a user-controlled maximum-parallel thread environment variable.

12. The method of claim 10 wherein determining the quantity of parallel threads that can be created comprises determining the quantity of parallel threads that can be created according to one or more environment variables

13. The method of claim 10 wherein determining the quantity of parallel threads that can be created comprises:
receiving a maximum thread indicator from the application launch argument list; and
setting the quantity of maximum parallel threads according to the maximum thread indicator.

14. The method of claim 8 wherein launching two or more parallel instances of the application comprises:
determining the quantity of input argument files included in the application launch argument list; and
launching a quantity of parallel instances of the application according to the quantity of input argument files.

15. A file processing system comprising:
processor capable of executing an instruction sequence;
memory;
console capable of receiving an argument list;
computer readable medium capable of storing one or more input files and further capable of storing an output stream;
instruction sequence modules stored in the memory including:
argument parser module that, when executed by the processor, minimally causes the processor to identify one or more input argument files in an argument list received by the console;
functional core module that, when executed by the processor, minimally causes the processor to direct an output stream to the computer readable medium according to an input file stored on the computer readable medium; and
task master module that, when executed by the processor, minimally causes the processor to:
create one or more instantiations of the functional core module;
direct to a corresponding instantiation of the functional core module an input argument file identified by the processor when it executes the argument parser; and
cause an assignee processor to execute each instantiation of the functional core module.

16. The file processing system of claim 15 wherein the task master module minimally causes the processor to create one or more instantiations of the functional core module by minimally causing the processor to:
determine the quantity of parallel threads that can be created; and
create a quantity of instances of the functional core module according to the determined quantity of parallel threads.

17. The file processing system of claim 16 wherein the task master module minimally causes the processor to determine the quantity of parallel threads that can be created by minimally causing the processor to determine the quantity of parallel threads according to at least one of a number of active processors in a system, a per-user maximum parallel thread system limitation and a user-controlled maximum-thread environment state variable.

18. The file processing system of claim 16 wherein the task master module minimally causes the processor to determine the quantity of parallel threads that can be created by minimally causing the processor to determine the quantity of parallel threads according to one or more environment variables.

19. The file processing system of claim 16 wherein the argument parser, when executed by the processor, further minimally causes the processor to extract a maximum thread indicator from the received argument list and wherein the task master module minimally causes the processor to determine the quantity of parallel threads that can be created by minimally causing the processor to set the quantity of parallel threads according to the maximum thread indicator.

20. The file processing system of claim 15 wherein the task master module minimally causes the processor to create one or more instantiations of the functional core module by minimally causing the processor to create a quantity of instantiations of the functional core according to the quantity of input argument files included in a received argument list.

21. The file processing system of claim 15 further comprising an output organizer module that, when executed by a processor, minimally causes the processor to collect output files from one or more instances of the functional core module once they are executed by a processor and further minimally causes the processor to organize the output files according to an order derived by the processor as it executes the argument parser in order to identify input argument files.

22. A file processing system comprising:
processor capable of executing an instruction sequence;
memory;
console capable of receiving an application launch directive that includes an argument list;
computer readable medium capable of storing one or more input files and further capable of storing an output stream; instruction sequence modules stored in the memory including:
command line parser module that, when executed by the processor, minimally causes the processor to:
identify in a received launch directive an application to be executed;
determine if the identified application is a candidate for enhancement;
identify one or more input argument files in an argument list included in the application launch directive;
generate for a task executive a plurality of load directives and corresponding instantiation argument lists when the identified application is a candidate for enhancement and when there are two or more input argument files in the argument list wherein a corresponding instantiation argument list includes one of the input argument files; and
task executive module that, when executed by the processor, minimally causes the processor to:
load into the memory according to the plurality of load directives and corresponding instantiation argument lists an application module that, when executed by the processor, minimally causes the processor to direct an output stream to the computer readable medium according to an input file stored on the computer readable medium;
direct to the application module a corresponding instantiation argument list generated by the command line parser; and
cause an assignee processor to execute the application module.

23. The file processing system of claim 22 wherein the command parser module causes the processor to determine if an identified application is a candidate for enhancement by minimally causing the processor to determine if the identified application is included in a pre-established enumeration of candidate applications.

24. The file processing system of claim 22 wherein the command parser module causes the processor to generate a plurality of load directives and corresponding instantiation argument lists by minimally causing the processor to:
determine the maximum quantity of parallel threads that can be created; and
generate a quantity of load directives and corresponding instantiation argument lists according to the determined maximum quantity of parallel threads.

25. The file processing system of claim 24 wherein the command parser module minimally causes the processor to determine the maximum quantity of parallel threads that can be created by minimally causing the processor to determine the quantity of parallel threads according to at least one of a number of active processors in a system, a per-user maximum parallel thread system limitation and a user-controlled maximum-thread environment state variable.

26. The file processing system of claim 24 wherein the command parser module minimally causes the processor to determine the maximum quantity of parallel threads that can be created by minimally causing the processor to determine the quantity of parallel threads according to one or more environment variables.

27. The file processing system of claim 24 wherein the command line parser, when executed by the processor, further minimally causes the processor to extract a maximum thread indicator from an argument list and wherein the command line parser module minimally causes the processor to determine the quantity of parallel threads that can be created by minimally causing the processor to set the quantity of parallel threads according to the maximum thread indicator.

28. The file processing system of claim 22 wherein the command line parser causes the processor to generate a plurality of load directives and corresponding instantiation argument lists by minimally causing the processor to:
determine the quantity of input file arguments included in the argument list; and
generate a quantity of load directives and corresponding instantiation argument lists according to the determined quantity of input files.

29. A computer readable medium having imparted thereon instruction sequence modules including:
argument parser module that, when executed by a processor, minimally causes a processor to identify one or more input argument files in a received argument list;
functional core module that, when executed by a processor, minimally causes a processor to direct an output stream to a computer readable medium according to an input file stored on the computer readable medium; and
task master module that, when executed by a processor, minimally causes a processor to:
create one or more instantiations of the functional core module;
direct to a corresponding instantiation of the functional core module an input argument file identified by a processor when it executes the argument parser; and
cause an assignee processor to execute each instantiation of the functional core module.

30. The computer readable medium of claim 29 wherein the task master module minimally causes a processor to create one or more instantiations of the functional core module by minimally causing the processor to:
determine the quantity of parallel threads that can be created; and
create a quantity of instances of the functional core module according to the determined quantity of parallel threads.

31. The computer readable medium of claim 30 wherein the task master module minimally causes a processor to determine the quantity of parallel threads that can be created by minimally causing a processor to determine the quantity of parallel threads according to at least one of a number of active processors in a system, a per-user maximum parallel thread system limitation and a user-controlled maximum-thread environment state variable.

32. The computer readable medium of claim 30 wherein the task master module minimally causes a processor to determine the quantity of parallel threads that can be created by minimally causing a processor to determine the quantity of parallel threads according to one or more environment variables.

33. The computer readable medium of claim 30 wherein the argument parser module, when executed by a processor, further minimally causes a processor to extract a maximum thread indicator from a received argument list and wherein the task master module minimally causes a processor to determine the quantity of parallel threads that can be created by minimally causing a processor to set the quantity of parallel threads according to the maximum thread indicator.

34. The computer readable medium of claim 29 wherein the task master module minimally causes a processor to create one or more instantiations of the functional core module by minimally causing a processor to create a quantity of instantiations of the functional core according to a quantity of input argument files included in a received argument list.

35. The computer readable medium of claim 15 further comprising an output organizer module that, when executed by a processor, minimally causes a processor to collect output files from one or more instances of the functional core module once they are executed by a processor and further minimally causes a processor to organize the output files according to an order derived by a processor as it executes the argument parser in order to identify input argument files.

36. A computer readable medium having imparted thereon instruction sequence modules including:
command line parser module that, when executed by a processor, minimally causes a processor to:
identify in a received launch directive an application to be executed;
determine if the identified application is a candidate for enhancement;
identify one or more input argument files in an argument list included in the application launch directive;
generate for a task executive a plurality of load directives and corresponding instantiation argument lists when the identified application is a candidate for enhancement and when there are two or more input argument files in the argument list wherein a corresponding instantiation argument list includes one of the input argument files; and
task executive module that, when executed by a processor, minimally causes a processor to:
load into the memory according to the plurality of load directives and corresponding instantiation argument lists an application module that, when executed by a processor, minimally causes a processor to direct an output stream to a computer readable medium according to an input file stored on the computer readable medium;
direct to the application module a corresponding instantiation argument list generated by the command line parser; and
cause an assignee processor to execute the application module.

37. The computer readable medium of claim 36 wherein the command parser module causes a processor to determine if an identified application is a candidate for enhancement by minimally causing a processor to determine if the identified application is included in a pre-established enumeration of candidate applications.

38. The computer readable medium of claim 36 wherein the command parser module causes a processor to generate a plurality of load directives and corresponding instantiation argument lists by minimally causing a processor to:
determine the maximum quantity of parallel threads that can be created; and
generate a quantity of load directives and corresponding instantiation argument lists according to the determined maximum quantity of parallel threads.

39. The computer readable medium of claim 38 wherein the command parser module minimally causes a processor to determine the maximum quantity of parallel threads that can be created by minimally causing a processor to determine the quantity of parallel threads according to at least one of a number of active processors in a system, a per-user maximum parallel thread system limitation and a user-controlled maximum-thread environment state variable.

40. The computer readable medium of claim 38 wherein the command parser module minimally causes a processor to determine the maximum quantity of parallel threads that can be created by minimally causing a processor to determine the quantity of parallel threads according to one or more environment variables.

41. The computer readable medium of claim 38 wherein the command line parser, when executed by the processor, further minimally causes a processor to extract a maximum thread indicator from an argument list and wherein the command line parser module minimally causes a processor to determine the quantity of parallel threads that can be created by minimally causing a processor to set the quantity of parallel threads according to the maximum thread indicator.

42. The computer readable medium of claim 36 wherein the command line parser causes the processor to generate a plurality of load directives and corresponding instantiation argument lists by minimally causing the processor to:
determine the quantity of input file arguments included in the argument list; and
generate a quantity of load directives and corresponding instantiation argument lists according to the determined quantity of input files.

43. A file processing system comprising:
means for receiving an application launch argument list;
means for identifying one or more input argument files in the application launch argument list;
means for creating two or more parallel threads when there are two or more input argument files; and
means for processing the input argument files using the parallel threads.

44. The file processing system of claim 43 wherein the means for creating two or more parallel threads comprises:
means for determining the maximum quantity of parallel threads that can be created; and
means for creating a quantity of parallel threads according to the quantity of parallel threads that can be created.

45. The file processing system of claim 44 wherein the means for determining the quantity of parallel threads that can be created comprises a means for determining the quantity of parallel threads that can be created according to at least one of a number of active processors, a per-user maximum parallel thread system limitation and a user-controlled maximum-parallel thread environment variable.

46. The file processing system of claim 44 wherein the means for determining the quantity of parallel threads that can be created comprises a means for determining the quantity of parallel threads that can be created according to one or more environment variables.

47. The file processing system of claim 44 wherein the means for determining the quantity of parallel threads that can be created comprises:
means for receiving a maximum thread indicator from the application launch argument list; and
setting the quantity of maximum parallel threads according to the maximum thread indicator.

48. A file processing system comprising:
means for receiving an application launch directive;
means for determining if the application launch directive specifies an application that is a candidate for enhancement;
means for receiving an application launch argument list;
means for launching two or more parallel instances of the application when the application is a candidate for enhancement and when there are a plurality of input argument files included in the application launch argument list; and
means for directing to each application instance an instantiation application launch argument list that includes a corresponding one of the input argument files included in the application launch argument list.

49. The file processing system of claim 48 wherein the means for determining if the application is a candidate for enhancement comprises a means for determining if the application is included in an enumeration of one or more candidate applications.

50. The file processing system of claim 48 wherein the means for launching two or more parallel instances of the application comprises:
means for determining the maximum quantity of parallel threads that can be created; and
means for launching a quantity of parallel instances of the application according to the maximum quantity of parallel threads.

51. The file processing system of claim 50 wherein the means for determining the maximum quantity of parallel threads that can be created comprises a means for determining the quantity of parallel threads that can be created according to at least one of a number of active processors, a per-user maximum parallel thread system limitation and a user-controlled maximum-parallel thread environment variable.

52. The file processing system of claim 50 wherein the means for determining the quantity of parallel threads that can be created comprises a means for determining the quantity of parallel threads that can be created according to one or more environment variables

53. The file processing system of claim 50 wherein the means for determining the quantity of parallel threads that can be created comprises:
means for receiving a maximum thread indicator from the application launch argument list; and
means for setting the quantity of maximum parallel threads according to the maximum thread indicator.

54. The file processing system of claim 48 wherein launching two or more parallel instances of the application comprises:
determining the quantity of input argument files included in the application launch argument list; and
launching a quantity of parallel instances of the application according to the quantity of input argument files.
